(19) United States
(12) Patent Application Publication
(10) Pub. No.: US 2008/0201022 A1
(43) Pub. Date: Aug. 21, 2008

(54) RECREATIONAL VEHICLE WARNING AND IDENTIFICATION SYSTEM RELATED APPLICATIONS

(75) Inventors: James A. Fields, Grand Rapids, MI (US); Benjamin P. Knapp, Dorr, MI (US); Curtis A. Buiskool, Kalamazoo, MI (US)

Correspondence Address: JAMES E. BARTEK, 3830 56TH STREET, GRANDVILLE, MI, 49418, US

(73) Assignee: PATENT WORKS, INC., Grand Rapids, MI (US)

(21) Appl. No.: 11/676,279

(22) Filed: Feb. 17, 2007

(51) Int. Cl. G06F 17/00

(52) U.S. Cl. 701/1; 340/425.5

(57) ABSTRACT

A novel warning and identification system for use on recreational vehicles of various types, such as snowmobiles or ATVs, is disclosed as comprising a housing with a display that projects a digital number that is mounted and oriented to provide oncoming riders with information concerning the number of participants in the user's group. The digital display may be set by the user using inputs that allow the entry of the desired number. In addition, the warning and identification system of the present invention includes a beacon for transmitting a select radio signal from the recreational vehicle and which can be recognized by an oncoming rider using a corresponding warning and identification system. Signal differentiation is generated by the unit and like-kind signals are filtered out to avoid confusion amongst the users within a group of riders.

### CROSS-REFERENCE TO RELATED APPLICATIONS

This is a continuing non-provisional application of co-pending U.S. Provisional Patent Application Ser. No. unknown, entitled Recreational Vehicle Warning And Identification System Related Applications and filed on about 18 Feb. 2006 by James A. Fields et alia, now expired, the disclosure of which is incorporated here by reference.

### BACKGROUND OF THE INVENTION

The present invention relates to an information system as used with recreational off-road vehicles and the like. More particularly, the present invention relates to a device that may, among other capabilities, be set to “display” specific information regarding the number of vehicles that a recreational vehicle user may be confronting. The display may include an information broadcast that originates with one recreational vehicle and is received with other riders of recreational vehicles, including oncoming vehicles.

The proliferation of various types of recreational vehicles in the United States has seen an almost logarithmic rate of growth. In some cases, recreational vehicles of the type that will be described within this document were not even available for use by the user as little as ten or fifteen years ago. Specifically, the types of recreational vehicles referred to herein include snowmobiles, quad runners, ATV's, motorized trail bikes, utility vehicles, and the like. A common link among these vehicles is that the user may use them on trails, paths, or backwoods roads where normal motor vehicle traffic is not found or may be restricted. The practice is sometimes called “off-roading” and the vehicles may at times be classed as off-road vehicles (ORVs).

In the case of snowmobiles, the existence of a sufficient snow base is required to allow the vehicle to operate, however after this the snowmobile may be driven “off road.” As is the practice in many areas, a group of snowmobilers may form up and travel as a group on trails that may run for tens or hundreds of miles in overall length. The same is true at time for users who are fans of other recreational vehicles. Runs or journeys of groups of ORVs may be organized, with these outings extending for hours, for a day, or more depending on the locale and the objectives of the participants. Trails that are used for these purposes are typically located in rural or forested areas, which adds to the enjoyment of the user who is able to take in the landscape and the environment that might not otherwise be accessible. The overall experience combines the beauty of a scenic outdoor trip with the company of good friends or like-minded recreational vehicle aficionados, which makes it easy to realize why this type of activity continues to become increasingly popular.

Along with the popularity of recreational vehicle outings, certain problems have arisen. One serious problem is safety related and this occurs sometimes when a group that is in the middle of one of the types of described outings meets an oncoming rider. Depending on then present circumstances, the trails may be narrow and certainly many times, the trail environment may be dark owing to weather, nighttime driving conditions, or the prevalence of a forest canopy. An oncoming rider is, therefore, not always able to see the full extent of a group that may be approaching and this lack of knowledge may led to severe consequences. Simply enough the oncoming rider may not see the lead rider of the group and meeting them at speed and on a narrow trail under conditions of reduced visibility means that a serious accident could happen. Many times, an oncoming rider will see the lights of the lead rider in a group and will slow down accordingly, stop, and/or pull over on the side of the common trail. There are times, however, when the oncoming rider assumes that the lead rider is the sole rider. Alternatively, if there is a gap between riders, the oncoming rider may assume that the whole group has already passed, when in fact his action in starting up and continuing may end up in a head on collision with remaining members of the group.

It can be appreciated that imparting information to the oncoming rider about the existence and extent of the group that he/she might be confronting would be an important consideration in reducing the number and severity of collisions between recreational vehicles of all types. In fact there have already been some attempts to provide warnings in one way or another to oncoming riders, including one device that is known in the prior art which is a headlamp that has been customized to flash or strobe. This signal is recognized immediately by the oncoming rider as an indication that something is approaching, however it does not provide any more information than this. There are other devices known in the prior art that do attempt to impart information including a lighting system that uses different colors to indicate the existence of a “tail” of riders following the leader of a group. The lead recreational vehicle and the last vehicle are given different colors to project while the vehicles in the middle all sport the same colored light. This information can be utilized by the oncoming rider but obviously the rider must first be aware of the meaning of the signal or the whole effect is lost.

Other types of indicators are known in the prior art that will give some sort of information about the existence, the location, or some qualitative or quantitative information about the situation that an oncoming rider might face. These include other variations on lights and also at times flags or similar accessories that may be affixed to a recreational vehicle. Many of these approaches share a common detriment in that they are binary indicators, that is, they only give one piece of information such as the use of a flag which tells the oncoming rider that there is a similar vehicle approaching. In addition, many of these prior art devices are fixed and cannot be modified to fit each circumstance that the user may be involved in. These deficits mean that there is very little useful information that can be imparted to oncoming riders, thereby severely reducing the usefulness of such devices.

Thus, a need is understood to exist for a way to impart useful information to ORV riders and to remain flexible enough to be able to characterize changing conditions as they occur.

### BRIEF SUMMARY OF THE INVENTION

Accordingly, a recreational vehicle identification and warning system of the invention comprises a proximity location reporting device that may be mountable onto a recreational vehicle and include a housing, a power supply, a display that reports information to oncoming riders, and inputs for setting the display. In a preferred embodiment of the present invention, the display may project a digital number that is selected by the user and which is oriented to be viewable by an oncoming rider. In another version, a warning and identification system can project a radio beacon that is set on a low wattage common frequency, which can be received by similar warning and identification systems installed on oncoming recreational vehicles. In one option of the present invention, the warning and identification system may be provided as a retrofit kit for installation by a user.

In other embodiments of the present invention, the warning and identification system may include a signal indication display that provides information to the user regarding the identification and strength of a beacon from an oncoming rider/recreational vehicle. Further, the warning and identification system may provide a contoured housing for placement on the rear of a recreational vehicle or for placement on the forward part of a cowling on a recreational vehicle.

The present invention may also impart information to the user as well, where in one embodiment the present invention is configured to receive inputs regarding the approach of oncoming riders or recreational vehicles. These and other attributes and features of the present invention will be discussed in more detail below and will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is a front, right, and upper perspective view of a snowmobile, showing a warning and identification device of the present invention installed behind a wind screen of the snowmobile; and

FIG. 2 is a back view thereof, showing a warning and identification display device of the present invention installed on a rear deck thereof,

FIG. 3 is a front view of a quad runner ATV, showing a warning and identification device of the present invention installed on a cowling; and

FIG. 4 is a back view thereof, showing a warning and identification display device of the present invention installed on a rear thereof,

FIG. 5 is a schematic representation of a front view of a warning and identification system of the present invention, showing a power supply connected with a display housing;

FIG. 6 is a back view thereof; and

FIG. 7 is a side view thereof;

FIG. 8 is schematic representation of a front view of an alternate embodiment of a warning and identification system of the present invention; and

FIG. 9 is a side view thereof; and

FIG. 10 is a diagrammatic representation of electrical components of a warning and identification system of the present invention, indicating a functional pathway for operation of the invention.

### DETAILED DESCRIPTION OF THE INVENTION

A preferred embodiment of a recreational vehicle warning and identification system according to the invention is generally shown in the drawing figures and discussed below. In at least one embodiment, a preferred system may include proximity location reporting. In a first concept of the invention, a system for providing a warning and for identification of possible oncoming riders or recreational vehicles for a user who is using a recreational vehicle of their own, is disclosed in the drawings and is discussed in detail herein. The warning and identification system may be operated to provide unilateral or bilateral indications relating to the status of recreational vehicle traffic conditions. The particular mode that is practiced by the user may be dependent upon such circumstances as may be discussed below but which do not limit the scope of the invention to a unilateral or bilateral system in any event.

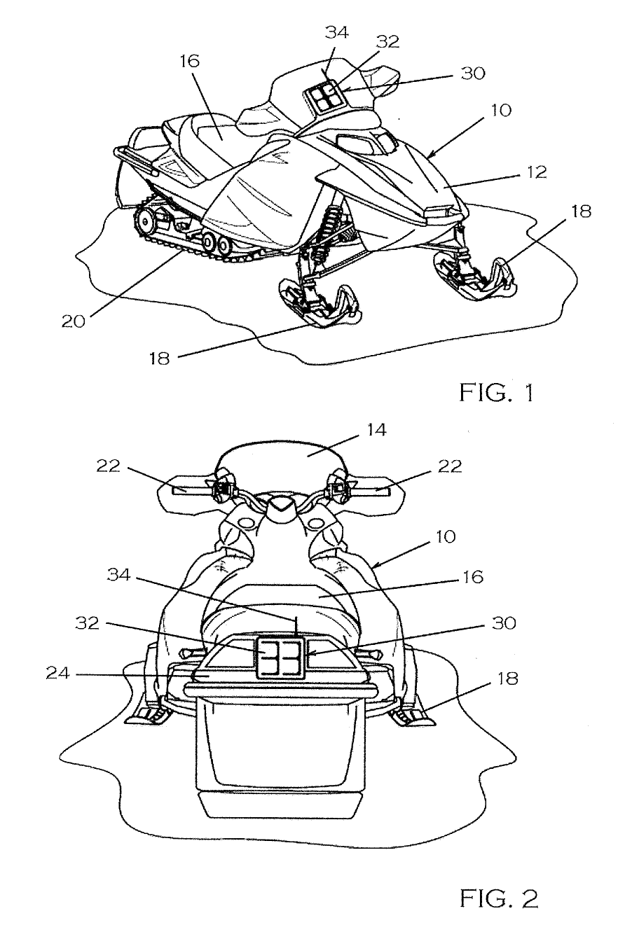

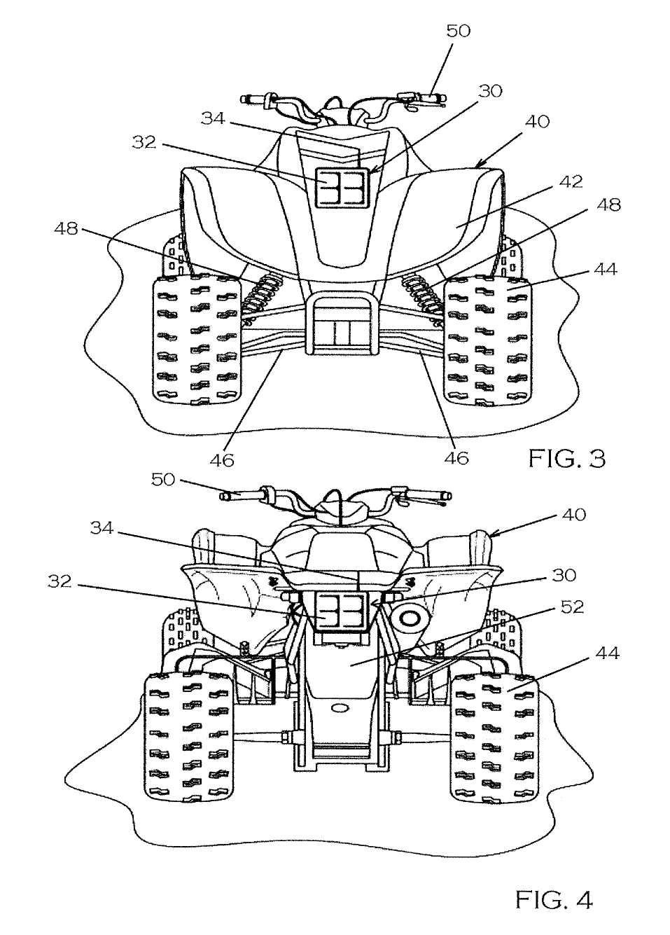

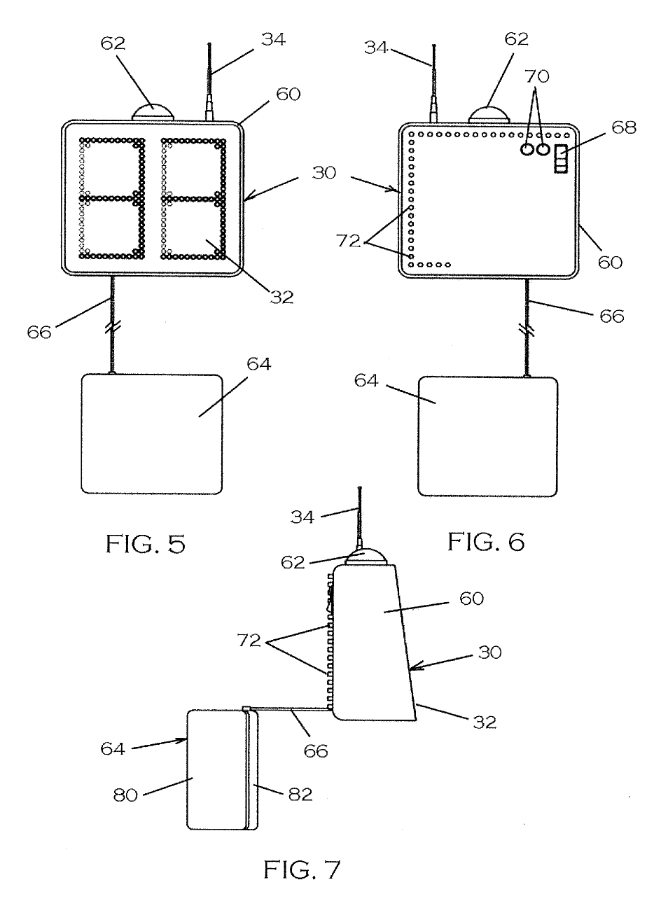

Turning to FIGS. 1 and 2, a conventional snowmobile 10 is shown with cowling 12, wind screen 14, seat 16, skis 18, track 20, handlebars 22 and rear deck 24. A warning and identification system 30 of the present invention is shown as installed, in one instance behind the wind screen 14 (FIG. 1), and as installed on the rear of the rear deck area 24 (FIG. 2). The warning and identification system 30 as shown includes a display 32 and a antenna 34. The warning and identification system 30 of the present invention may also be installed on the front of an ATV 40 (FIG. 3), where the ATV 40 includes a cowling 42, wheels 44, suspension 46, shocks 48, and handlebars 50, or at a rear portion 52 (FIG. 4). Specifics of the warning and identification system 30 may include a housing 60, a strobe 62, a power supply 64, a power supply line 66, an on/off switch 68, digital setting inputs 70, a signal strength indicator 72, and a battery case 80 with a battery case door 82 (FIGS. 5,6 and 7).

In the present embodiment, the warning and identification system 30 may be considered as being designed primarily for after-market applications. The housing 60 is compact and preferably has a relatively slim profile that allows it to be installed in a tight area such as the wind screen 14. The actual method of attachment is not shown in the drawings and may be any form, permanent or temporary, that one skilled in the art may see fit to employ. Placement of the warning and identification system 30, notably the housing 60 and the display 32, is typically made to ensure visibility such that when the unit is installed in the front of the recreational vehicle, either 10 or 40 and the like, the display 32 is viewable by oncoming riders, and similarly when installed on the rear of a recreational vehicle, the display 32 is viewable by those coming from behind.

The display 32 may preferably be comprised of LED (Light Emitting Diode) lamps set into a pattern that may be selected to form digital numbers with selected illumination of specific LEDs of the pattern. Other forms of number displays may be used although considerations for such use may include the level of illumination that is achieved as well as the power supply needed for continuous operation of the warning and identification system 30. The display 32 may be energized by a on/off switch 68, which will cause the power supply 64 to be connected to the LEDs when turned to the “on” position. The actual number that is displayed is controlled by user manipulation of the digit setting inputs 70 which are provided, in the case of the present embodiment, for each of the two number sections that make up the display 32. By depressing the digit input settings 70, this will allow the user to increment the numbers from “0” through “9” that will appear on the display 32. In this fashion, any number from “00” to “99” may be made to appear on the display 32 with a relatively small number of actions on the part of the user. In the usual case, the number that is made to appear on the display will correspond to the number of recreational vehicles 10/40 that will be riding in the group behind that particular user. The effect is that the user, while riding their recreational vehicle 10/40 will be projecting information to an oncoming rider about the number of vehicles that follow. This is important for the reasons noted above regarding safety issues that arise during trail riding, the information informs the oncoming rider(s) what to expect and avoids a potential for collisions. In addition there is a convenience factor for the oncoming rider in merely knowing how long he/she will be compelled to wait.

In addition to the digital information that is projected from the display 32, the warning and identification system 30 of the present embodiment includes a strobe 62 that can be activated. The strobe 62 offers another visual indication of the presence of the user which helps to alert the oncoming rider(s).

The warning and identification system 30 further includes a beacon that allows a radio signal to be emitted through the antenna 34. The frequency for the radio signal can be pre-set or provisions may be made for allowing adjustment of the frequency by the user. At the same time the signal indicator 72 would be activated on the user's own unit. The signal indicator 72 provides a series of LEDs that proportionately show the strength of any incoming beacon signal that might be broadcast from oncoming recreational vehicles 10/40. The signal strength representing a rough gage as to the distance of the oncoming rider(s) to the user's unit. Thus the beacon system has a potential for operating in two directions; receiving and transmitting. Obviously the radio frequency for each beacon cannot operate the same way otherwise the signal indicators 72 for a group of riders will all show a maximum indication (or nearly maximum) all the time they are riding as a group. Given the ability to electronically massage signals, the transmitter that is used to produce the radio signal can be made to broadcast in a recognizable pattern, much like a coded transmission. This may be a digital message, or it may result from measured bursts of radio transmissions that are identifiable by the number of repeats within a given cycle. In any event, the corresponding receiving units in each of the warning and identification systems 30 would, upon receipt, be able to recognize the transmission and either filter it out if it was a signal type that is emitted by a member in the group, or allow it to be displayed on the signal indicator 72 if it was perceived as coming from a recreational vehicle from outside the group. This allows each warning and identification system 30 to distinguish between the beacons and when appropriate, to display the threat of an oncoming recreational vehicle in a way that will not only catch the eye of the user, but will give some indication as to the distance of the oncoming rider(s).

As may be appreciated, the warning and identification system 30 of the present embodiment would have to be synchronized with the beacons that are being transmitted within the group. This can be accomplished in any number of ways, for instance, the group may all purchase their warning and identification systems 30 at the same time, ensuring that their pre-set frequencies are all identical. This would assume that the group would remain static and would become problematic if additional members wanted to join a group for a trail ride. While a control is not shown in the drawings, it would easily be within the ability of one skilled in the art to provide input for setting the radio frequency of the beacon accordingly. In fact, the existing controls of the warning and identification system 30 as shown could be employed such that the digital setting inputs 70 could double as frequency settings, merely by incorporating a step such as holding down one or both of the digital setting inputs 72 for a selected time, such as five seconds, which would then signal the transmitter that the frequency setting was to be changed. Using the digital setting inputs 70, a number of potential frequencies can be inputted and could be made to correspond to the number range of “00” to “99” with the actual frequency or type of encoded radio signal being emitted being controlled by the transmitter based upon each inputted setting. In this fashion a group of riders can coordinate their beacon signals and proceed with some assurance that the likelihood that any oncoming rider(s) that are similarly using a beacon would most likely have set their systems to a different setting. Thus signal differentiation occurs and the information that each group receives has value.

The placement of the warning and identification system 30 of the present invention onto a recreational vehicle 10/40 is subject to numerous considerations. While the design type of a recreational vehicle in a particular group, such as snowmobiles 10 or ATVs 40, may be similar, certainly differences exist between such vehicles as snowmobiles 10 or ATVs 40. Thus it is an objective of the present invention to be compatible with different types of installation platforms while providing a convenient and relatively easy method for the installation process. The housing 60 of the preferred embodiment is compact but still provides the necessary sized display 32 for use. The actual size may vary, but a housing 60 with a thickness of 2″, height of 12″ and width of 10″ would serve the purposes of the present invention without being unduly difficult to place and install. Placement, as may be inferred from the drawings, may be made at the front or rear of the subject recreational vehicle 10 or 40. The advantage of the size of the warning and identification system 30 is that it can easily be fitted to the recreational vehicle. Typically installation will require no more than modest hardware such as clamps or brackets or similar. The power supply 64 is preferably supplied as a separate battery source, which mayor may not be connected electrically to the power supply of the recreational vehicle. The placement of the power supply 64 is less critical than the placement of the housing 60, or more specifically the display 32, and all that is needed is to run the power supply line 66 between the two. One advantage in having a separate power supply 64 is the ability to power the warning and identification system when the recreational vehicle is turned off. This would keep the beacon active as well as the strobe 62 and may serve as aids to oncoming riders during such times as the user is stopped for a rest or when the user's machine has stopped running for any reason.

The present embodiment contemplates an after market application although there is no reason where the warning and indication system 30 may not be employed as original equipment on a recreational vehicle. The components of the present invention can easily be integrated into a recreation vehicle design without losing any of the functionality discussed herein.

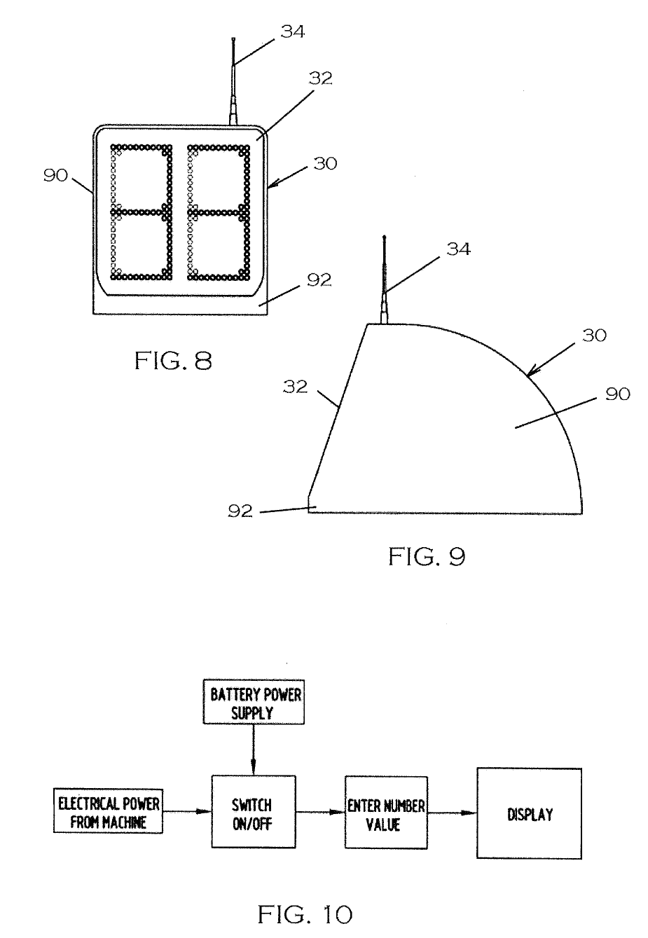

Another version of the present invention is shown in FIGS. 8 and 9, where a contoured housing 90 is revealed with a housing base 92. The benefits of this embodiment result from an ability to provide a sealed housing 90 that can be placed forward on the cowling 12 of a recreational vehicle 10 thereby eliminating the vision obstruction that might occur from the placement of the previous embodiment immediately behind the wind screen 14. The housing base 92 is adaptable to installation onto the cowling 12 and may be permanently affixed.

Variations on the embodiments may be made without affecting the functionality of the present invention. The embodiments discussed are merely preferred and exemplary ways of expressing the invention and means by which it may be employed. It is also possible to practice the invention without the inclusion of all of the functional features, for instance, the strobe 62 may be eliminated from either embodiment without affecting the function of the beacon or the digital number display. Similarly, the beacon may be eliminated without affecting the function of the strobe 62 or the digital number display, and so forth. While the discussion has related to recreational vehicles, numerous other applications exist where the present invention could be deployed, such as golf carts, floats or vehicles in a parade, dune buggies, and the like. Suffice to say that the application of the present invention is left to one skilled in the art insofar as the compatibility with installation and for each use to which it may be employed.

Nothing herein is intended in any way to limit or restrict the scope of the present invention and the examples shown are meant for illustration of various ways that the invention may be employed and benefits that may be realized. One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, may be used in this detailed description of the invention and in the claims only to convey relative positioning of various elements of the claimed invention without limitation to the invention.

What is claimed is:

1. A recreational vehicle warning and identification system, comprising:
a housing, the housing being adapted to mount on an off road vehicle so that the housing is visible to an observer who looks at one of a front of the vehicle and a back of the vehicle;
a display supported by the housing, the display being adapted to display to the observer a preselected image such that the image is visible by the observer in at least one of a daytime and a nighttime condition;
a processor located in the housing and operatively connected with the display, the processor being adapted to control the display so that a preselected image is displayed by the display;
a power supply operatively connected with the processor; and
an input operatively connected with the processor whereby a user selects an image that the display displays.

2. The system defined in claim 1, wherein the display displays an image of a numeral.

3. The system defined in claim 1, further including a mounting bracket that is mounted on the off road vehicle and wherein the housing is adapted to removably couple with the mounting bracket, so that the housing may be selectively coupled with various mounting brackets, whereby one housing may be used with a selected one of various off road vehicles.

4. The system defined in claim 1, further including:
an antenna connected with the housing and operatively connected with the processor; and
a signal indicator operatively connected with the processor; and
wherein the processor is adapted to receive an identifying signal through the antenna;
wherein the processor is adapted to evaluate a relative strength of the identifying signal received;
wherein the processor is adapted to control the signal indicator so that a relative signal strength of the identifying signal received is indicated with the signal indicator;
wherein the processor is adapted to generate an unique identifying signal; and
wherein the processor is adapted to transmit the unique identifying signal through the antenna.

5. The system defined in claim 4, wherein the housing, display, processor, power supply, input, antenna, and signal indicator define a first transceiver that is adapted to transmit and receive identifying signals and wherein the system includes a second transceiver.

6. The system defined in claim 5, wherein each transceiver processor is adapted so that a user may preselect the unique identifying signal generated by the processor and so that the processor does not evaluate the preselected unique identifying signal.

7. The system defined in claim 5, wherein each transceiver processor is adapted so that a user may preselect at least one unique identifying signal that the processor does not evaluate.

8. A recreational vehicle warning and identification system, comprising:
a display, the display being adapted to mount on an off road vehicle so that the display is visible to an observer who looks at one of a front of the vehicle and a back of the vehicle, the display also being adapted to display to the observer a preselected image such that the image is visible by the observer in at least one of a daytime and a nighttime condition;
a processor operatively connected with the display, the processor being adapted to control the display so that a preselected image is displayed by the display;
a power supply operatively connected with the processor; and
an input operatively connected with the processor whereby a user selects an image that the display displays.

9. The system defined in claim 8, wherein the display displays an image of a numeral.

10. The system defined in claim 8, further including a mounting bracket that is mounted on the off road vehicle and wherein the housing is adapted to removably couple with the mounting bracket, so that the housing may be selectively coupled with various mounting brackets, whereby one housing may be used with a selected one of various off road vehicles.

11. The system defined in claim 8, further including:
an antenna connected with the housing and operatively connected with the processor; and
a signal indicator operatively connected with the processor; and
wherein the processor is adapted to receive an identifying signal through the antenna;
wherein the processor is adapted to evaluate a relative strength of the identifying signal received;
wherein the processor is adapted to control the signal indicator so that a relative signal strength of the identifying signal received is indicated with the signal indicator;
wherein the processor is adapted to generate an unique identifying signal; and
wherein the processor is adapted to transmit the unique identifying signal through the antenna.

12. The system defined in claim 11, wherein the housing, display, processor, power supply, input, antenna, and signal indicator define a first transceiver that is adapted to transmit and receive identifying signals and wherein the system includes a second transceiver.

13. The system defined in claim 12, wherein each transceiver processor is adapted so that a user may preselect the unique identifying signal generated by the processor and so that the processor does not evaluate the preselected unique identifying signal.

14. The system defined in claim 12, wherein each transceiver processor is adapted so that a user may preselect at least one unique identifying signal that the processor does not evaluate.
